(19) United States
(12) Patent Application Publication
(10) Pub. No.: US 2018/0178221 A1
(43) Pub. Date: Jun. 28, 2018

(54) MAGNETIC IRON PARTICLES SEPARATING SYSTEM

(71) Applicant: GENOBIO CORP., Seoul (KR)

(72) Inventors: JAE KU LEE, Gyeonggi-do (KR); SUNG HOON PARK, Seoul (KR); JU HYUN HWANG, Seoul (KR); GWANG YEOL PARK, Seoul (KR)

(21) Appl. No.: 15/738,230

(22) PCT Filed: Apr. 1, 2016
(86) PCT No.: PCT/KR2016/003426

§ 371 Date: Dec. 20, 2017

(30) Foreign Application Priority Data
Jul. 17, 2015 (KR) 10-2015-0101985

(51) Int. Cl. B03C 1/033; B03C 1/01; B03C 1/06; B03C 1/20

(52) U.S. Cl. CPC B03C 1/0332; B03C 1/01; B03C 2201/18; B03C 1/20; B03C 1/06

(57) ABSTRACT

The present invention relates to a magnetic iron particle (MIP) separating system for separating the magnetic beads existing in the mixed solution.

### TECHNICAL FIELD

The present invention relates to a magnetic iron particle (MIP) separating system for separating the magnetic beads existing in the mixed solution.

### BACKGROUND ART

The blood circulates blood vessels of the human or the animals, and transports oxygen absorbed in the lungs to the tissue cells, and transports carbon dioxides from the tissue to the lungs and exhausts out.

In addition, the blood transports nutrients absorbed in the alimentary canal to the organs or the tissue cells, and transports decomposition products of the tissues which are unnecessary matters for the living body to the kidney and exhausted out from the body, and transports hormone secreted from the endocrine glands to the working organs and the tissues.

Meanwhile, cancer cells in the blood refer to cancer cells existing in the peripheral blood of the cancer patients, and they are the cancer cells dropout from the original focus site or the metastasis focus.

Such cancer cells in the blood are expected to be a strong bio-marker in the area of such as cancer diagnosis, post treatment analysis, analysis of micro-metastasis, and the like.

Furthermore, analysis of cancer cells in the blood is very promising as a method for cancer diagnosis in the future since it is a non-invasive method which is an advantage over the methods of cancer diagnosis of the prior art.

However, since the distribution ratio of a cancer cell in the blood is extremely low as one cancer cell per 1 billion total cells or one cancer cell per 106 to 107 of white blood cells, accurate analysis is very difficult and very elaborate analysis method is required.

At present time, the biggest issues in the method of cell separation currently used in cancer diagnosis, analysis of blood cell, and the like are the productivity and the efficiency thereof.

That is, fast separation speed, high separation efficiency, and the like are required.

In order to suffice the productivity issue, most of the existing technologies have been adopted a method wherein cells are being filtered through the mechanical structures.

On the other hand, although methods for separating cells using electric field, densities, and the like have been disclosed, most of them showed limitations in sufficing the productivity issues.

Moreover, when using a mechanical structure, problems occur in that cells are being stuck to the structure or extracting the separated cells again becomes difficult.

Therefore, although the speed of cell separation is high, there is an additional problem in that the separation efficiency of cell separation is reduced.

In order to solve the problems of such a method for cell separation utilizing mechanical structures, a method for separating cells utilizing magnetic property has been disclosed.

First, a mixed solution is prepared including cancer cells combined with magnetic nanoparticles by mixing the magnetic nanoparticles (so called as ‘magnetic beads’) combined with antibody having specific reaction on cancer cells and the blood to be tested.

The technologies of the prior art, wherein a mixed solution and a buffer solution (buffer, for example distilled water) are being flowed into a chip wherein channels are formed, and the respective flows are controlled appropriately in accordance with the viscosity of the fluids, and the cancer cells in the blood are being separated from the blood thereby, are summarized as follows.

(1) Prior Art 1 disclosed in Korea Patent Publication No. 2013-0103282 is a method for inducing cancer cells combined with magnetic nanoparticles by installing one or a plurality of magnets in the outside of the channels of the chip.

However, the Prior Art 1 has a disadvantage in that the separation efficiency of the magnetic beads is low.

(2) Prior Art 2 disclosed in Korea Patent Publication No. 2013-0095485 is a method for separating magnetic beads by the plurality of magnets disposed spaced apart with a predetermined distance in the outside of the channel of the chip.

That is, Prior Art 2 is a method wherein magnetic beads are separated in each of the magnets disposed spaced apart with a predetermined distance as the mixed solution is being flowed through the channel of the chip.

However, the Prior Art 2 also has a disadvantage in that the separation efficiency of the magnetic beads is low.

(3) Prior Art 3 disclosed in Korea Patent No. 1212030 is a method of separation wherein magnets are installed spaced apart with a predetermined distance in the upper portion inside the channel of the chip or in the sidewall thereof.

That is, Prior Art 3 is method of separation by letting the magnetic beads be directly stuck to the magnets, and the initial separation efficiency thereof is higher than that of Prior Art 1 or Prior Art 2.

However, there is a disadvantage in that the separation efficiency is decreased as the magnetic beads are being stuck more to the magnets.

Prior Arts 1 to 3 are the separation methods based on magnetic or electro-magnetic induction.

(4) Prior Art 4 disclosed in Korea Patent No. 1211862 is about a magnetic induction method and has an advantage in that the separation efficiency is relatively high compared to those of Prior Arts 1 to 3.

The magnetic beads in the mixed solution that had been flowed in through the both sides via the wire pattern formed in chip are being separated in the center of the ferromagnetic wire pattern by magnetic induction.

Although the separation efficiency is higher than those of Prior Arts 1 to 3, there are problems as follows:

1) In the case of the chip used in Prior Art 4, the manufacturing cost of the chip is very high since wire patterns based on semiconductor technologies are used.

2) Damages to the wire pattern when cleaning inside of the chip during the cleaning process for recycling of the chip and the existence of residual substances after the cleaning process are the problems.

3) The air possibly remaining inside the chip during the cleaning process of the chip will function as an obstacle during the separation process of the magnetic beads.

4) The dimensions may be changed since the upper plate of the chip is made of a flexible material, and solid fixation cannot be ensured when fixing the inlet for a buffer solution or a mixed solution.

### DISCLOSURE OF INVENTION

### Technical Problem

The objective of the present invention, devised for solving above described problems, is to provide an economical magnetic iron particle (MIP) separating system having a high separation efficiency of the magnetic beads and a low manufacturing cost of the chip as well.

### Solution to Problem

In order to achieve such objective, a magnetic iron particle (MIP) separating system according to the present invention is characterized in that and includes:

a chip including a channel; and

a plurality of magnets imparting magnetic force to the chip, wherein

the magnets and the chip are relatively moving to each other.

The magnetic iron particle (MIP) separating system according to the present invention is characterized in that a plate is formed in the lower side of the chip, and the magnets are formed on the plate, wherein the plate is moving rotationally.

The magnetic iron particle (MIP) separating system according to the present invention is characterized in that the magnets are plurally formed on the plate, and the magnets are disposed along the circumference or the radius of the plate, wherein a difference in the magnetic force exists between a magnet and its neighboring magnet.

The magnetic iron particle (MIP) separating system according to the present invention is characterized in that the difference in the magnetic force is produced by the height difference between a magnet and its neighboring magnet, or the size difference between a magnet and its neighboring magnet.

The magnetic iron particle (MIP) separating system according to the present invention is characterized in that the plate is a circular plate, and the magnets disposed on the plate include a first magnet group, and a second magnet group which is crossly disposed to the first magnet group.

The magnetic iron particle (MIP) separating system according to the present invention is characterized in that and includes: a third magnet group disposed between the first magnet group and the second magnet group; and a fourth magnet group crossly disposed to the third magnet group.

The magnetic iron particle (MIP) separating system according to the present invention is characterized in that the magnets are regularly or irregularly disposed on the plate.

The magnetic iron particle (MIP) separating system according to the present invention is characterized in that the plate is moving eccentrically and rotationally with respect to the center of the plate.

The magnetic iron particle (MIP) separating system according to the present invention is characterized in that and includes a belt located in the lower side of the chip, and the magnets are disposed on the belt.

The magnetic iron particle (MIP) separating system according to the present invention is characterized in that the belt is disposed surrounding a first pulley and a second pulley, and a driving unit for driving the first pulley or the second pulley is further provided.

The magnetic iron particle (MIP) separating system according to the present invention is characterized in that the belt includes a first belt located in the lower side of the chip, and a second belt spaced apart from the first belt and located in the lower side of the chip.

The magnetic iron particle (MIP) separating system according to the present invention is characterized in that a first driving unit driving the first belt, and a second driving unit driving the second belt are further included.

The magnetic iron particle (MIP) separating system according to the present invention is characterized in that the magnets are plurally disposed on the belts, and the horizon separation distance between a magnet and its neighboring magnet is a, and the vertical separation distance is b.

The magnetic iron particle (MIP) separating system according to the present invention is characterized in that and further includes:

a fifth magnet group wherein a plurality of magnets are disposed side by side in a single line, and the distance between a magnet and its neighboring magnet is same; and

a sixth magnet group disposed in parallel with the fifth magnet group, wherein the fifth magnet group and the sixth magnet group are disposed repeatedly.

The magnetic iron particle (MIP) separating system according to the present invention is characterized in that the magnets are plurally and irregularly disposed on the belt.

The magnetic iron particle (MIP) separating system according to the present invention is characterized in that in any one of the Claims 1 to 15 the magnets are formed by combining a plurality of magnets.

The magnetic iron particle (MIP) separating system according to the present invention is characterized in that a slope is formed in the channel.

The magnetic iron particle (MIP) separating system according to the present invention is characterized in that a step is formed in the channel.

The magnetic iron particle (MIP) separating system according to the present invention is characterized in that a slope and a step are formed in the channel.

The magnetic iron particle (MIP) separating system according to the present invention is characterized in that the chip is comprised of an upper plate and a lower plate being coupled to the upper plate, and the channel further includes a step height formed in the upper plate or in the lower plate, wherein the height of the channel is constant along the lengthwise direction of the chip.

The magnetic iron particle (MIP) separating system according to the present invention is characterized in that the chip is slantly disposed with respect to the magnets.

### Advantageous Effects of Invention

The magnetic iron particle (MIP) separating system according to the present invention has advantages as follows:

(1) The separation efficiency of the magnetic beads is significantly enhanced since the magnets are rotating and continuously impart magnetic force to the magnetic beads within the chip.

(2) The flow of magnetic beads between the neighboring magnets can be made smooth by disposing magnets in the rotating plate in a way that height differences are formed along the radial direction.

(3) The phenomenon wherein the magnetic beads are being pushed backwards can be prevented by disposing magnets in the rotating plate in a way that height differences are formed along the circumferential direction.

(4) It is economical since common materials (for example, plastics) are used when manufacturing chip.

(5) The recycling processes such as cleaning and the like are unnecessary since disposable chips are used.

(6) The separation efficiency of the magnetic beads is not decreased even air is remaining inside the chip.

(7) When the size of the chip is enlarged in lengthwise, the separation efficiency of the magnetic beads is enhanced by increasing the separation speed.

### BRIEF DESCRIPTION OF DRAWINGS

FIG. 1 is a perspective view of a magnetic iron particle (MIP) separating system according to the present invention.

FIG. 2 is a layout diagram of the magnets on the plate of a magnetic iron particle (MIP) separating system according to the present invention.

FIG. 3 is a layout diagram of the magnets on a plate of a magnetic iron particle (MIP) separating system according to the present invention.

FIG. 4 is a perspective view of a direct driving type eccentric plate of a magnetic iron particle (MIP) separating system according to the present invention.

FIG. 5 is a perspective view of a direct driving type plate of a magnetic iron particle (MIP) separating system according to the present invention.

FIG. 6 is a schematic diagram of the magnets disposed along the radial direction on the plate of a magnetic iron particle (MIP) separating system according to the present invention.

FIG. 7 is a schematic diagram of the magnets disposed along the circumferential direction on the plate of a magnetic iron particle (MIP) separating system according to the present invention.

FIG. 8 is a perspective view illustrating a belt driving type of another preferred exemplary embodiment of the present invention.

FIG. 9 is a perspective view illustrating an independent belt driving type of yet another preferred exemplary embodiment of the present invention.

FIG. 10 are the layout diagrams of magnets on a belt in a belt driving type of still another preferred exemplary embodiment of the present invention.

FIG. 11 is a schematic diagram of a magnet, wherein a plurality of magnets is combined, of a magnetic iron particle (MIP) separating system according to the present invention.

FIG. 12 is a perspective view of a chip of a magnetic iron particle (MIP) separating system according to the present invention.

FIG. 13 is a plan view of a lower plate of a chip of a magnetic iron particle (MIP) separating system according to the present invention.

FIG. 14 is a perspective view of an upper plate of a chip of a magnetic iron particle (MIP) separating system according to the present invention.

FIG. 15 is a perspective view of a chip of a magnetic iron particle (MIP) separating system according to the present invention.

FIG. 16 is a plan view of a lower plate of a chip of a magnetic iron particle (MIP) separating system according to the present invention.

FIG. 17 is a plan view of an upper plate of a chip of a magnetic iron particle (MIP) separating system according to the present invention.

FIG. 18 is a schematic diagram of the step heights formed inside a chip of a magnetic iron particle (MIP) separating system according to the present invention.

FIG. 19 is a cross-sectional view of a channel formed inside a chip of a magnetic iron particle (MIP) separating system according to the present invention.

FIG. 20 is a layout diagram of a chip and the magnets of a magnetic iron particle (MIP) separating system according to the present invention.

### MODE FOR THE INVENTION

Hereinafter, a magnetic iron particle (MIP) separating system 10 according to the present invention will be described in detail with reference to the drawings.

In the detailed description of a magnetic iron particle (MIP) separating system 10 according to the present invention, the expression “in ˜” means that something is directly in contact with the corresponding member, or a third member can be interposed therebetween.

First, a magnetic iron particle (MIP) comprises magnetite (Fe3O4), maghemite (gamma Fe2O3), cobalt ferrite, manganese ferrite, and the like, and as for specific examples, there are magnetic beads, magnetic iron particle beads, magnetic iron nanoparticle beads, superparamagnetic agarose beads, and the like.

In the description hereinafter magnetic bead is the representative example of an MIP.

First, the mixed solution flowing into the channel CH of the chip 200 is prepared by mixing the magnetic nanoparticles combined with antibody having specific reaction on cancer cells and the blood to be tested.

The blood may include normal cells PU (specified substances of Class 1) such as white blood cells, and cancer cell A PS1 (specified substances of Class 2) and cancer cell B PS2 (specified substances of Class 3) which are different to each other.

When the types of cancer cells PS2 and PS3 are different, the numbers of markers (for example, antigens) expressed on the cancer cells are different.

There is a big difference in the numbers of the makers expressed per one cancer cell depending on cancer types, as for the epithelial cellular adhesion molecule (EpCAM), such as: the numbers of expressed EpCAM per SKBr-3 breast cancer cell are about 500,000; the numbers of expressed EpCAM per PC3-9 prostate cancer cell are about 50,000; and the numbers of expressed EpCAM per T-24 bladder cancer cell are about 2,000, and so on.

Thus, the antibodies having specific reaction on EpCAM are combined to the magnetic nanoparticles, and when these magnetic nanoparticles are being mixed with the blood of a cancer patient, a big difference occurs in the numbers of the magnetic nanoparticles being combined to a cancer cell depending on the cancer type of the cancer cell.

In this way, the difference in the numbers of magnetic nanoparticles combined per cell is utilized in separating cancer types using a magnetic force.

Meanwhile, a buffer solution such as distilled water is flowed into the buffer solution inlet 220b.

The buffer solution separately injected through the buffer solution inlet 220b of the chip and the mixed solution entered through the mixed solution inlet 220a are being flowed in the channel CH of the chip 200, and the both flows seem not to interfere with each other's flow.

However, the magnetic beads are tends to be drawn towards the buffer solution due to the magnetic force of the magnets 150.

As previously described, magnetic nanoparticles or iron particles are called magnetic beads.

Magnetic force is imparted to the lower side of the chip 200.

Any material having the property of magnetic material can be used as a magnetic force, and typically, Ni, Co, and Fe or a compound material of these elements can be used.

Magnetic force plays the role of interrupting the flow of particles by attracting the particles having a magnetic property inside the fluid body.

A magnetic iron particle (MIP) separating system 10 according to the present invention includes a chip 200 including a channel CH, and a plurality of magnets 150 imparting magnetic force to the chip 200.

First, the magnetic iron particle (MIP) separating system 10 includes a base 20.

A turn table 60, a driving unit (not shown), and a Z-axis and angle adjustment device 70 are formed in the upper side of the base 20.

A controller 30 and a driver 40 are further included in the upper side of the base 20 for controlling the driving unit, and a power supply unit 35, a SMPS, is further included.

A chip holder 50 is combined in the upper side of the Z-axis and angle adjustment device 70.

The chip holder 50 is protrudedly formed directing towards the center of the plate 100 from the Z-axis and angle adjustment device 70 which is combined to the upper side thereof, and has a cantilever type supporting structure.

One end of the chip holder 50 is combined to the upper side of the Z-axis and angle adjustment device 70.

The Z-axis and angle adjustment device 70 plays the role of adjusting distance and angle between the chip holder 50 and the plate 100 which will be described later.

The chip 200 will be laid on the chip holder 50.

The magnets 150 imparting magnetic force to the chip is moving towards the chip 200.

Or, the chip 200 is moving towards the magnets 150.

Eventually, the chip 200 and the magnets 150 are moving relative to each other.

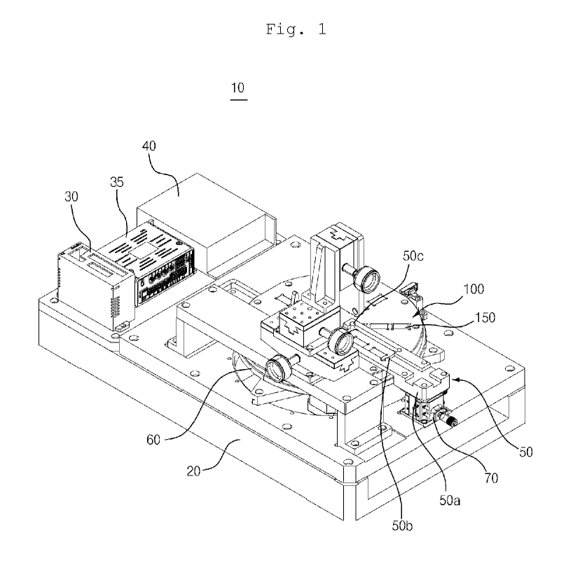

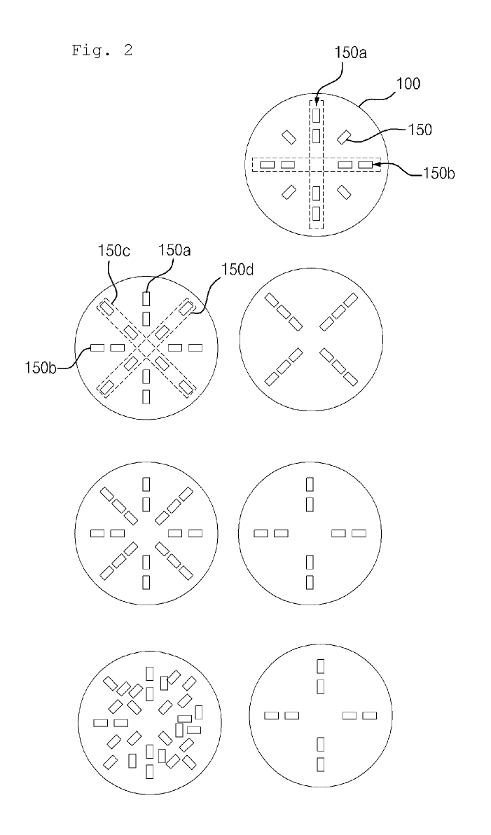

It can be explained with reference to FIG. 1 as follows:

One end 50a of the chip holder 50 is combined on the upper surface of the Z-axis and angle adjustment device 70.

The portion from the center 50b of the chip holder 50 to the other end 50c thereof is located in the upper side of the plate 100.

The chip 200 is being laid on the chip holder 50 located in the upper side of the plate 100, and specifically, the chip 200 is preferably located between the center 50b and the other end 50c of the chip holder 50 in order to impart magnetic force to the chip 200.

The plate 100 is located in a turn table 60 located in the lower side of the plate 100, and the plate 100 is rotated by the turn table 60.

For reference, the method for driving the turn table 60 can be classified into two types: (1) indirect driving method, and (2) direct driving method.

According to the indirect driving method, the turn table 60 is driven by a belt, and the belt is connected to the pulleys.

And the pulleys are driven by a motor.

According to the direct driving method, the turn table 60 is directly driven by the motor installed in the lower side of the turn table 60.

Since the chip 200 is laid on the chip holder 50 located in the upper side of the plate 100, on the contrary, the plate 100 is installed in the lower side of the chip 200.

Meanwhile, the magnets 150 imparting magnetic force to the chip 200 is formed on the plate 100.

If a single magnet is formed on the plate 100, magnetic force is imparted to the chip 200 only once per rotation of the plate.

Such configuration is disadvantageous to the other exemplary embodiments of the present invention in the aspects of the speed in separating the magnetic beads in the mixed solution inside the channel CH of the chip 200.

Therefore, in order to increase the speed of separating the magnetic beads, it is preferred that the magnets 150 are plurally disposed on the plate 100, and configured to have a variety of magnet layouts.

The magnets 150 are plurally formed on the plate 100.

At this time, a magnetic force difference exists between the two neighboring magnets disposed along the circumferential direction of the plate 100, and such magnetic force difference can be implemented by the height difference between the magnet 150 and the chip 200.

Let one magnet be M1 among the plurally disposed magnets along the circumferential direction of the plate 100.

Let the magnet located behind the magnet M1 along the circumferential direction of the plate 100 be M2.

When the plate 100 is being rotated, the magnets 150 plurally disposed along the circumferential direction of the plate 100 impart magnetic force to the chip 200.

One magnetic bead is moving towards the magnetic bead outlet 220c inside the channel CH of the chip 200 by the magnetic force of M1.

If the magnetic force of M2, which is a magnet located behind the M1, is same as that of M1; the magnetic beads induced and separated by the magnetic force of M1 again move backward inside the channel CH of the chip 200 due to the magnetic force of M2.

That is, a ‘backing effect’ occurs wherein magnetic beads are moving −Q (minus theta) direction.

Therefore, adjustment of the magnetic force is necessary in order to separate magnetic beads efficiently, and this can be achieved for the magnets 150 plurally disposed along the circumferential direction of the plate 100 by placing a difference in the magnetic forces between a magnet and its neighboring magnet with respect to the magnet, for example, by placing a height difference between the magnet 150 and the chip 200.

A magnetic force difference exists between a magnet and its neighboring magnet in the magnets 150 plurally disposed along the radial direction of the plate 100, and such magnetic force difference can be implemented through the height difference between the magnet 150 and the chip 200.

Let one magnet with respect to the radial direction of the plate 100 be M3, and let another magnet more closely located towards the center of the plate 100 be M4.

Assume a case wherein a magnetic bead has passed across M3 and been moved towards the magnetic bead outlet 220c inside the channel CH of the chip 200 by the magnetic force of M4.

If the magnetic force of M3 disposed more distant from the center of the plate 100 than M4 is same as that of M4; the magnetic bead, that has to pass across M3 and move towards the magnetic bead outlet 220c by the magnetic force of M4, is moving backward again by the magnetic force of M3.

In other words, the backing effect is occurring wherein the magnetic bead is being moved towards +R direction (direction getting far away from the center of the plate 100).

Therefore, adjustment of the magnetic force is necessary in order to make the flow of the magnetic beads smoothly, and this can be achieved for the magnets 150 plurally disposed along the circumferential direction of the plate 100 by placing a difference in the magnetic forces between a magnet and its neighboring magnet with respect to the magnet, for example, by placing a height difference between the magnet 150 and the chip 200.

The shape of the plate 100 located in the turn table 60 is preferred to be a circular plate.

This is because the rotation of the plate 100 is easy when the shape of the plate 100 located in the turn table 60 is a circular plate, and it is easy to impart magnetic force to the chip 200 successively by a plurality of magnets 150 disposed on the plate 100.

However, the shape of the plate 100 is not limited to the shape of a circular plate; even the rectangular shape is possible for the shape of the plate 110 if the plate 100 is located in a turn table 60 and can be rotated in accordance with the rotation of the turn table 60.

Hereinafter, the layout of the magnets 150 disposed on the plate 100 will be described.

(1) A plurality of magnets 150 disposed on the plate 100 includes a first magnet group 150a.

The first magnet group 150a is disposed on the plate 100 along the diametric direction of the plate 100.

A second magnet group 150b is crossly disposed to the first magnet group 150a, and the first magnet group 150a and the second magnet group 150b are disposed forming a right angle to each other.

In order to enhance the separation efficiency of magnetic beads, the magnets disposed on the plate 100 may further include a third magnet group 150c and a fourth magnet group 150d.

(2) The third magnet group 150c is also disposed on the plate 100 along the diametric direction of the plate 100.

The fourth magnet group 150d is crossly disposed to the third magnetic group 150c, and the third magnet group 150c and the fourth magnet group 150d are disposed forming a right angle to each other.

Meanwhile, since the third magnet group 150c is disposed between the previously described first magnet group 150a and the second magnet group 150b, the fourth magnet group 150d disposed at a right angle with the third magnet group 150c is also disposed between the first magnet group 150a and the second magnet group 150b.

In the description above, it is described that the first magnet group 150a and the second magnet group 150b are forming a right angle to each other, and the third magnet group 150c and the fourth magnet group 150d are forming a right angle to each other; however, forming an angle other than right angle is also possible in another exemplary embodiment; and an additional magnet group other than those previously described may possibly disposed on the plate 100 if the flow of the magnetic bead is smoothed as the chip 200 and the magnets 150 are moving relatively to each other in another exemplary embodiment.

If the layout is for installing magnets as many as possible in order to enhance the separation efficiency of magnetic beads, a plurality of magnets 150 may be irregularly disposed within the width along the radial direction of the plate 100.

The description heretofore is based on the rotational movement of the plate 100 occurring with reference to the center of the plate 100.

The rotational movement of the plate 100 can be eccentrically performed with respect to the center of the plate 100 according to another preferred exemplary embodiment of the present invention.

That is, when the center of the plate 100 and the center of the driving unit 80 are displacedly located to each other, the rotational movement of the driving unit 80 results in an eccentric rotational movement of the plate 100.

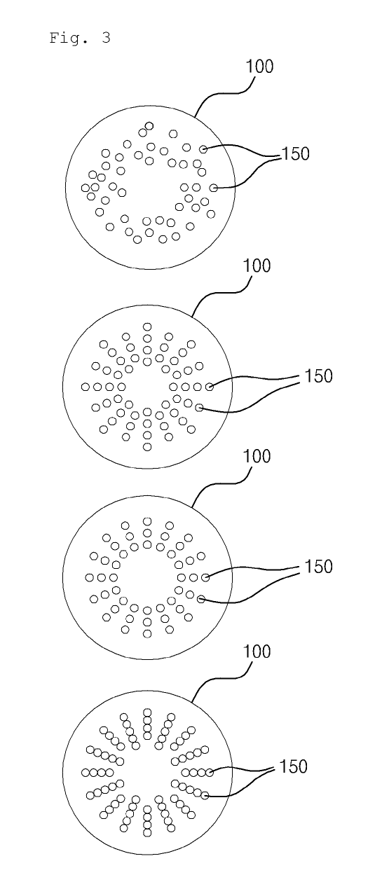

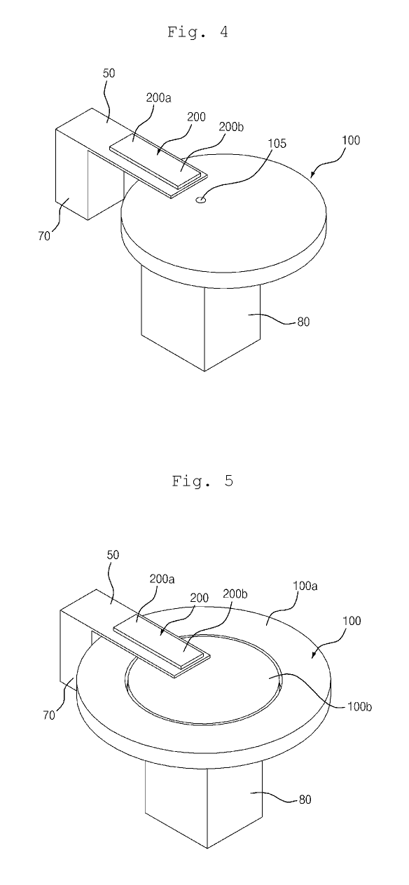

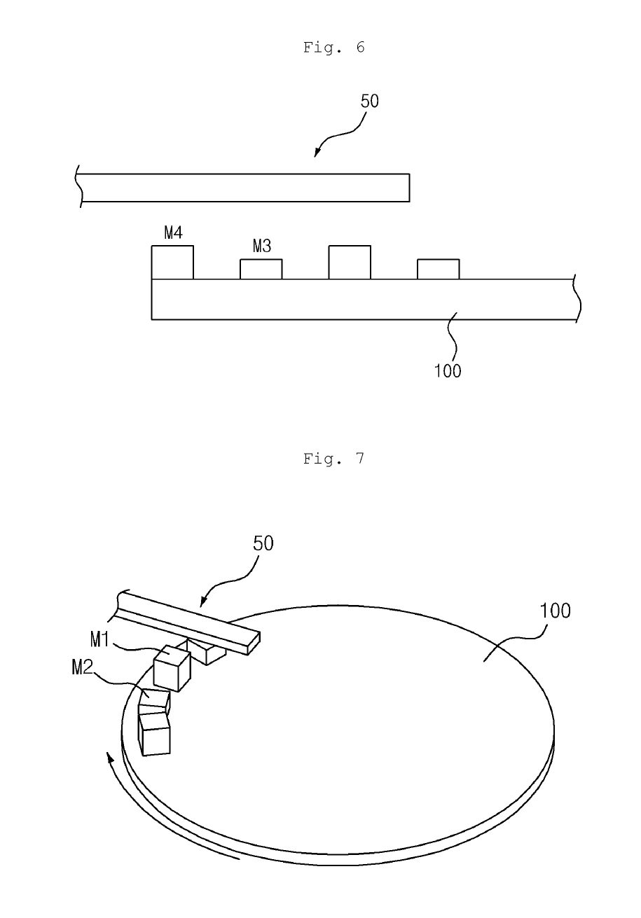

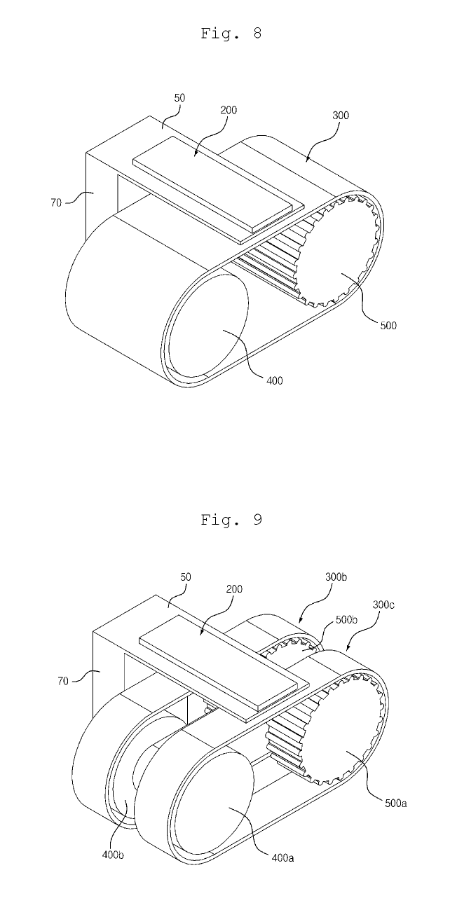

The eccentric axis 105 illustrated in FIG. 4 is eccentrically formed away from the center of the plate 100.

When the plate 100 is moving eccentrically and rotationally with respect to the driving unit 80, the magnetic force imparting to the chip 200 laid on the chip holder 50 affects differently as the plate 100 is moving eccentrically and rotationally.

Therefore, the separation efficiency of magnetic beads can be enhanced since variations in the magnetic force imparting to the chip 200 becomes possible even without forming the difference in the magnetic force of the magnets 150 along the circumferential or the radial direction of the plate 100 previously described, for example, the height difference between the magnets 150.

As illustrated in FIG. 5, the plate 100 can be configured to have an inner wheel 100b and an outer wheel 100a which are separated from each other.

In a configuration wherein the inner wheel 100b and the outer wheel 100a are being separated from each other, rotational directions of the inner wheel 100b and the outer wheel 100a can be set differently from each other.

At this time, the driving unit 80 driving the inner wheel 100b and the outer wheel 100a is preferably configured to utilize an independent driving method.

When the rotational directions of the inner wheel 100b and the outer wheel 100a are same, the separation efficiency and the separation speed of magnetic beads can be enhanced by introducing a difference in their speeds of rotation.

In a magnetic iron particle (MIP) separating system 10 according to the present invention, the following exemplary embodiments promote the separation of magnetic beads due to the magnets 150 disposed in a belt 300.

That is, the belt 300 is located in the lower side of the chip 200, and a plurality of magnets 150 is disposed on the belt 300.

Disposing of the magnets 150, being disposed on the belt 300, in a plural number is advantageous in the aspects of separation efficiency of the magnetic beads.

The belt can be rotated in clockwise or counter clockwise direction referring to the directions in the drawings, and in such a way the belt 300 is rotating infinitely.

For an infinite rotation of the belt 300, a first pulley 400 and a second pulley 500 are located inner side of the belt 300.

Thus, the belt 300 is disposed surrounding the first pulley 400 and the second pulley 500.

By driving the first pulley 400 or the second pulley 500, the belt 300 disposed surrounding the first pulley 400 and the second pulley 500 is moving infinitely.

In the preferred exemplary embodiment of the present invention, the second pulley 500 is being driven.

A driving unit (not shown) is coupled to the first pulley 400 or the second pulley 500, and preferably a motor and the like is used as such driving unit.

A Z-axis and angle adjustment device 70 is further provided in the one end 50a of the chip holder 50.

The Z-axis and angle adjustment device 70 plays the role of adjusting the distance or the angle between the chip 200 and the belt 300 so that the strength of the magnetic force imparting to the chip 200 can be adjusted.

The belt 300 can be moved infinitely by using an independent driving method in order to further enhance the induction efficiency of the magnetic beads by adjusting the magnetic force imparting to the chip 200 more precisely.

Thus, a first belt 300a and a second belt 300b are located in the lower side of the chip 200.

While the second belt 300b is located so as to be spaced apart from the first belt 300a, the belt 300 must be located in the lower side of the chip 200.

The first belt 300a is coupled to the first driving unit (not shown) for imparting the driving power.

The second belt 300b is coupled to the second driving unit (not shown) for imparting the driving power.

In this way, when the first belt 300a and the second belt 300b, located spaced apart a predetermined distance from each other, are coupled to the independent driving units respectively; then, the speeds of the infinite orbital movements of the first belt 300a and the second belt 300b can be adjusted and set differently from each other.

If the speeds of the infinite orbital movements of the first belt 300a and the second belt 300b can be controlled and set differently from each other, the magnetic beads inside the channel CH of the chip 200 can be induced and separated more precisely.

That is, the magnetic beads can be more precisely induced towards the magnetic bead outlet 220c by setting the speed of the infinite orbital movements of the belt located closer to the magnetic bead outlet 220c slower than the speed of the infinite orbital movements of the belt located closer to the mixed solution inlet 220a.

On the other hand, the magnetic beads can be more precisely induced towards the magnetic bead outlet 220c and separated by setting the layouts of the magnets 150 in the first belt 300a and the second belt 300b differently while the speeds of the infinite orbital movements of the first belt 300a and the second belt 300b are maintained equally.

The magnets 150 can be plurally disposed on the belt 300.

Let the horizontal separation distance between a set of neighboring magnets be a, and let the vertical separation distance between the set of neighboring magnets be b.

At this time, the magnets 150 disposed on the belt 300 can be disposed in various ways by setting a and b differently such as a<b or a>b, of course, a and b can be set equally.

A fifth magnet group 150e is formed on the belt 300, wherein a plurality of magnets is disposed side by side along the diagonal direction in a single line, and the separation distances between the neighboring magnets are same.

Through this, the dead zones, having no magnetic force, in the channel CH of the chip 200 wherein can be eliminated.

A sixth magnetic group 150f is disposed in parallel with the fifth magnet group 150e.

Since the fifth magnet group 150e and the sixth magnetic group 150f are disposed in parallel, also a plurality of magnets is disposed side by side along the diagonal direction in a single line in the sixth magnetic group 150f, so the separation distances between the neighboring magnets become equal.

In the belt, the fifth magnet group 150e and the sixth magnetic group 150f are repeatedly disposed.

In a case wherein the flow of the magnetic beads becomes smooth through the relative movements between the chip 200 and the magnets 150, a plurality of magnets 150 may be irregularly disposed on the belt 300 in order to enhance the separation efficiency of the magnetic beads.

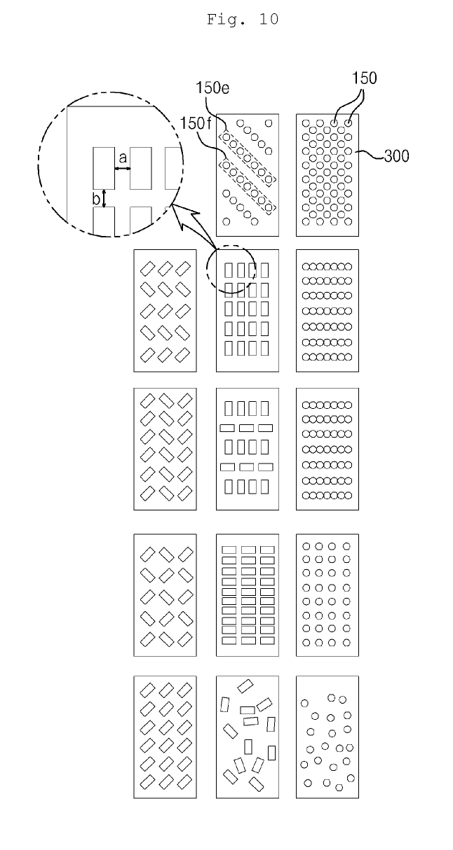

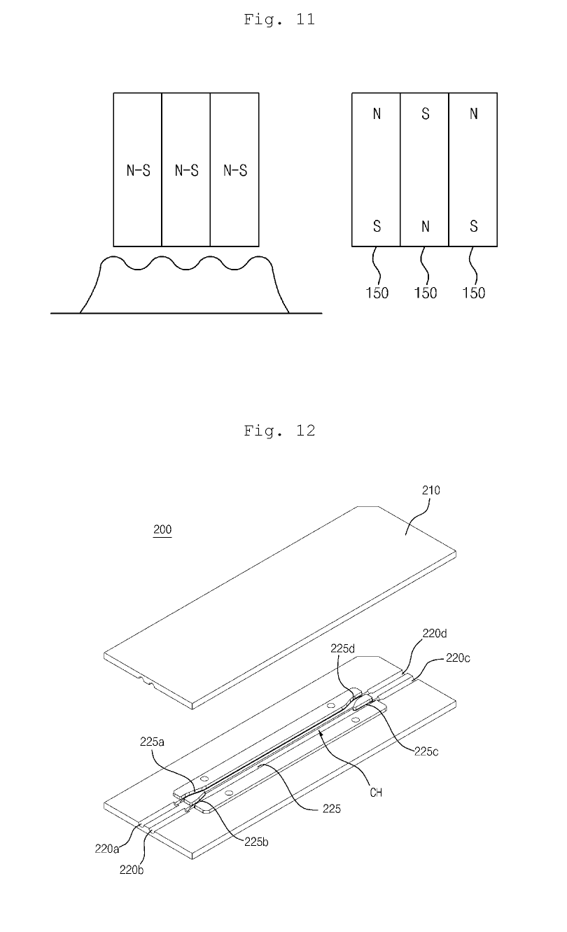

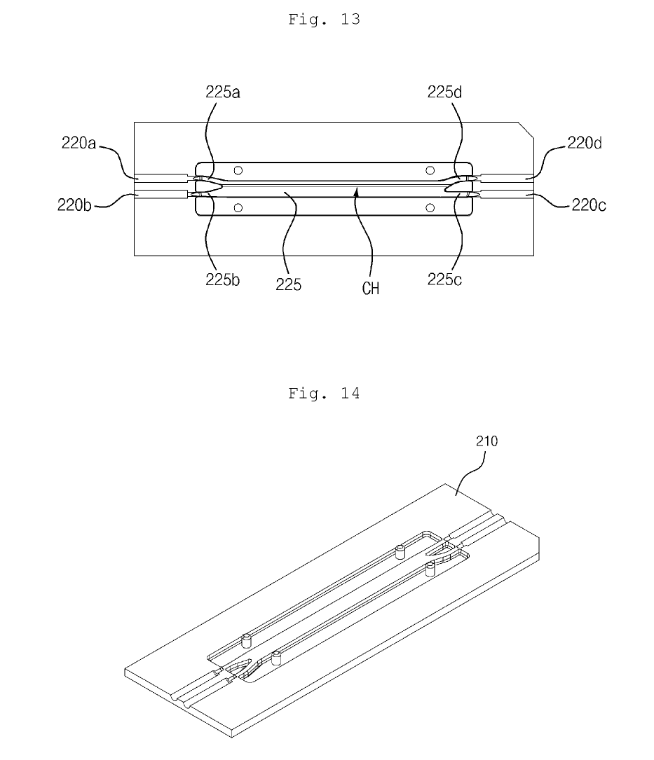

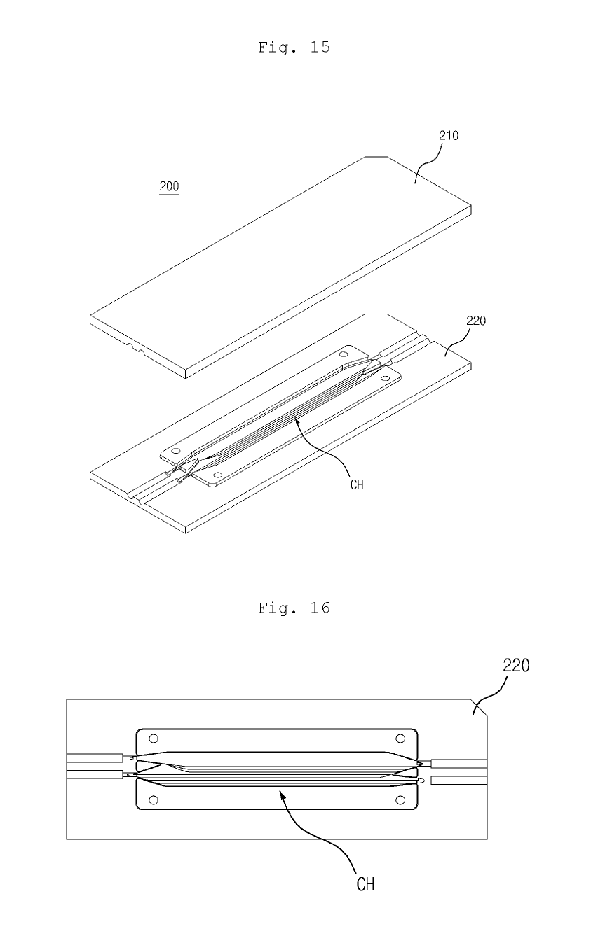

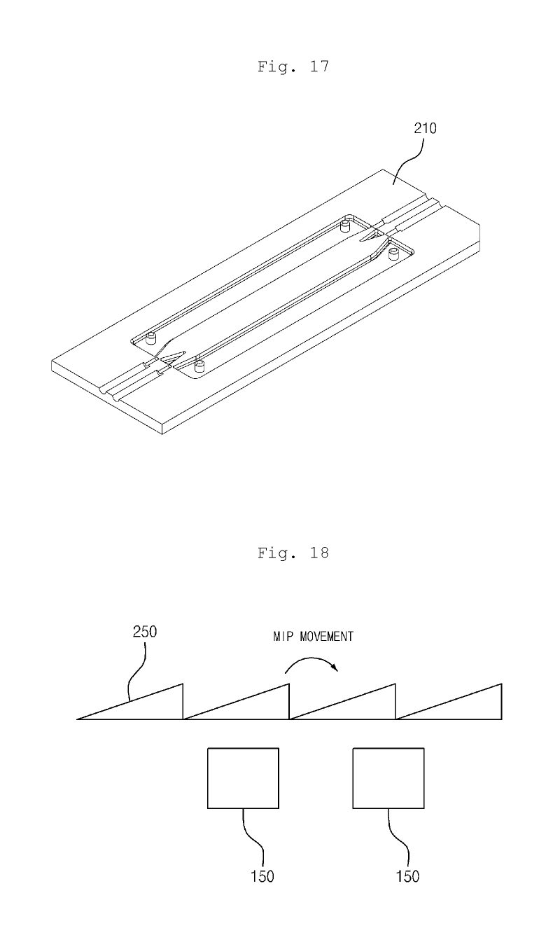

In the description above, the magnets 150 disposed on the plate 100 or the belt 200 can be formed by combining a plurality of magnets. (Refer to FIG. 11)

That is, explaining with reference to a bar magnet, an N pole is formed in one end of the magnet, and an S pole is formed in the other end of the magnet.

While the strength of the magnetic force is highest at the N pole and the S pole, the magnetic strength at the middle point where the N pole and the S pole meet is almost non-existing or negligible.

If, as shown in the drawings, a plurality of magnets are combined and being used as a single magnet, the magnetic strength can be increased at the middle point where the N pole and the S pole meet without significantly increasing the installation space of the magnets disposed on the plate or the belt.

That is, although the magnetic strength at the point where the N pole and the S pole meet is negligible, the magnetic strength can be increased at the middle point where the N pole and the S pole meet since the plurality of magnets are overlapped with each other.

In this way, when a single magnet is formed by combining a plurality of magnets, the magnetic strength at the middle point where the N pole and the S pole meet is increased, thereby resolving the un-uniformity of the magnetic strength and enhancing the induction and separation efficiencies of the magnetic beads.

The shape of a chip 200 of the magnetic iron particle (MIP) separating system is as follows:

The chip 200 is comprised of an upper plate 210 and a lower plate 220 having the shape of a flat rectangular plate in general.

A channel CH is formed by combining the upper plate 210 of the chip 200 and the lower plate 220 of the chip 200.

First, a recessed portion 225 and multiple holes 220a to 220d are formed in the lower plate 220 of the chip 200.

The multiple holes 220a to 220d include a mixed solution inlet 220a wherein a mixed solution is injected, and a buffer solution inlet 220b wherein a buffer solution such as a saline solution is injected.

The mixed solution inlet 220a wherein a mixed solution is injected and the buffer solution inlet 220b wherein a buffer solution such as a saline solution is injected are formed in one side 200a of the chip 200.

In addition, the multiple holes 220a to 220d include a magnetic bead outlet 220c for discharging the magnetic beads and a miscellaneous particle outlet 220d for discharging other particles.

The magnetic bead outlet 220c for discharging the magnetic beads and a miscellaneous particle outlet 220d for discharging other particles are formed in the other side 200b of the chip 200.

The lower plate 220 of the chip 200 is coupled with the upper plate of the chip 200.

Through such coupling, a channel CH and a plurality of paths 225a to 225d are formed between the recessed portion 225, formed in the lower plate 220 of the chip 200, and the inner side surface of the upper plate 210 of the chip 200.

The plurality of paths 225a to 225d include a mixed solution path 225a connecting the mixed solution inlet 220a and the channel CH, and a buffer solution path 225b connecting the buffer solution inlet 220b and the channel CH.

The plurality of paths 225a to 225d include a magnetic particle path 225c connecting the magnetic bead outlet 220c and the channel CH, and a miscellaneous particle outlet 225d connecting the miscellaneous particle outlet 220d and the channel CH.

The previously described recessed portion 225 is referred to be formed in the lower plate 220 of the chip 200; however, it can be formed in the upper plate 210 of the chip 200.

A slope is formed inside the channel CH in the magnetic iron particle (MIP) separating system according to the present invention.

The separation speed and the efficiency of the magnetic beads are enhanced by forming a declining slope inside the channel 200 towards the magnetic bead outlet 220c.

A height difference 250 is formed inside the channel CH towards the magnetic bead outlet 220c in the magnetic iron particle (MIP) separating system according to the present invention.

The magnetic beads flowing inside the channel CH of the chip 200 are induced by a magnet M1 disposed on the plate 100 or the belt 300, but then again they may flow backward by the magnetic force of the magnet M2 located behind the M1.

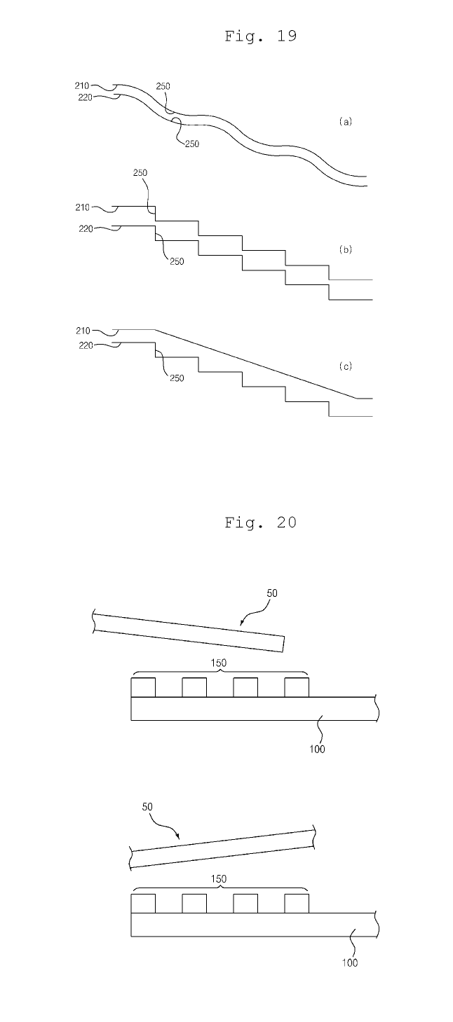

In order to prevent such backward flow of the magnetic beads height differences 250 are formed inside the channel CH as illustrated in FIG. 19.

The backing effect, wherein the magnetic beads are moving backward, can be prevented by the height differences 250 formed inside the channel CH.

The height differences 250 formed inside the channel CH are formed in the channel CH in the shape of stairs according to a preferred exemplary embodiment of the present invention.

A combination of a slope and the stair-type height difference 250 can be formed inside the channel CH in the magnetic iron particle (MIP) separating system according to the present invention.

In such a way, when the combination of a slope and the stair-type height difference 250 is formed inside the channel CH, the separation speed and the efficiency of the magnetic beads are enhanced during the flow of the magnetic beads, and the backing effect, wherein the magnetic beads are moving backward, can be prevented as well.

The channel CH is formed by the recessed portion 225 formed in the upper plate 210 or the lower plate 220 of the chip 200.

As described above, the recessed portion 225 can be formed in the upper plate 210 of the chip 200 or in the lower plate 220 of the chip 200.

IF the height of the channel CH is maintained constant with respect to the lengthwise direction of the chip 200, the variations in the flow speed inside the channel CH can be reduced.

It is apparent that when the variations in the flow speed inside the channel CH is reduced, the separation speed and the efficiency of the magnetic beads are enhanced.

The chip 200 according to the magnetic iron particle (MIP) separating system 10 according to the present invention is comprised of an upper plate 210 and a lower plate 220 being coupled to the upper plate 210.

The channel CH further includes the height differences 250 formed in the upper plate 21 of the chip 200 or the lower plate 220 of the chip 200.

The height of the channel CH is maintained constant with respect to the lengthwise direction of the chip 200.

When the height differences 250 formed in the upper plate 210 of the chip 200 or the lower plate 220 of the chip 200 are to be included inside the channel CH, the height differences 250 corresponding to the height differences 250 formed in the lower plate 220 of the chip 200 must be formed in the upper plate 210 of the chip 200 in order to maintain the height of the channel CH constant with respect to the lengthwise direction of the chip 200.

The chip 200 may be disposed slanted with respect to the magnets 150.

As described above, the chip 200 is located in the chip holder 50 which is located on the plate 100 or the belt 300; and basically, the chip 200 and the magnets 150, disposed on the plate 100 or the belt 300, are located in parallel with each other.

However, the flow of magnetic beads in the channel CH may not be smooth due to the interference of the magnetic forces between the plurality of magnets 150 disposed on the plate 100 or the belt 300.

In other words, during the induction process of the magnetic beads towards the desired direction, if magnetic forces working on the magnetic beads are equal, their flow in the channel CH will not be smooth.

Therefore, it is necessary that the magnetic force working towards the lengthwise direction with respect to the chip 200, more specifically, towards the magnetic bead outlet 220c, should be larger than the magnetic force working on the mixed solution path 225a.

The chip 200 may be slanted to have a declining slope with respect to the magnets 150 so that the magnetic force working towards the magnetic bead outlet 220c is larger than the magnetic force working on the mixed solution path 225a.

In this way, when disposing the chip 200 to have a declining slope with respect to the magnets 150, the magnetic force working towards the magnetic bead outlet 220c is larger than the magnetic force working on the mixed solution path 225a.

Thus, the magnetic beads can be induced towards the magnetic bead outlet 220c with fast speed.

When disposing the chip 200 to have an inclining slope with respect to the magnets 150, the magnetic force working towards the magnetic bead outlet 220c is smaller than the magnetic force working on the mixed solution path 225a.

When disposing in this way, the magnetic beads can be induced towards the magnetic bead outlet 220c more precisely.

As illustrated in FIG. 20, since the chip 200 is laid on the chip holder 50, slanting of the chip holder 50 has same effect as slanting of the chip 200.

A person who has common knowledge in this technical field shall understand that the present invention may be embodied in various modified forms without departing from the fundamental characteristics of the present invention. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced herein. In addition, various exemplary embodiments disclosed in the present invention may be implemented through a variety of combinations thereof.

### INDUSTRIAL APPLICABILITY

The magnetic iron particle (MIP) separating system according to the present invention is economical since it has a high separation efficiency of the magnetic beads and a low manufacturing cost of the chip as well.

1. A magnetic iron particle (MIP) separating system characterized in that and including:
a chip including a channel; and
a plurality of magnets imparting magnetic force to said chip, wherein: a plate is formed in the lower side of said chip; said magnets are formed on said plate; said magnets and said chip are relatively moving to each other; said plate is moving rotationally; said magnets are plurally formed on said plate; said magnets are disposed along the circumference or the radius of said plate; and a difference in the magnetic force exists between a magnet and its neighboring magnet.

2. The magnetic iron particle (MIP) separating system according to claim 1, characterized in that said difference in the magnetic force is produced by the height difference between a magnet and its neighboring magnet, or the size difference between a magnet and its neighboring magnet.

3. The magnetic iron particle (MIP) separating system according to claim 1, characterized in that said plate is a circular plate; and said magnets disposed on said plate include:
a first magnet group; and
a second magnet group which is crossly disposed to said first magnet group.

4. The magnetic iron particle (MIP) separating system according to claim 3, characterized in that and including:
a third magnet group disposed between said first magnet group and said second magnet group; and
a fourth magnet group crossly disposed to said third magnet group.

5. The magnetic iron particle (MIP) separating system according to claim 1, characterized in that said magnets are irregularly disposed on said plate.

6. A magnetic iron particle (MIP) separating system characterized in that and including:
a chip including a channel, wherein: a plate is formed in the lower side of said chip; a plurality of magnets imparting magnetic force to said chip are disposed on said plate; said plate is moving rotationally so that said magnets and said chip are relatively moving to each other; and said plate is moving eccentrically and rotationally with respect to the center of said plate.

7. A magnetic iron particle (MIP) separating system characterized in that and including:
a chip including a channel;
a belt located in the lower side of said chip; and
a plurality of magnets disposed on said belt and imparting magnetic force to said chip, wherein: said magnets and said chip are relatively moving to each other; and said belt includes: a first belt located in the lower side of said chip; and a second belt spaced apart from said first belt and located in the lower side of said chip.

8. The magnetic iron particle (MIP) separating system according to claim 7, characterized in that and further including: a first driving unit driving said first belt; and
a second driving unit driving said second belt.

9. A magnetic iron particle (MIP) separating system characterized in that and including:
a chip including a channel;
a belt located in the lower side of said chip, wherein a plurality of magnets imparting magnetic force to said chip are disposed on said belt; and said magnets and said chip are relatively moving to each other; and further including:
a fifth magnet group wherein a plurality of magnets are disposed side by side in a single line, and the distance between a magnet and its neighboring magnet is same; and
a sixth magnet group disposed in parallel with said fifth magnet group, wherein said fifth magnet group and said sixth magnet group are disposed repeatedly.

10. A magnetic iron particle (MIP) separating system characterized in that and including:
a chip including a channel;
a belt located in the lower side of said chip; and
a plurality of magnets disposed on said belt and imparting magnetic force to said chip, wherein said magnets and said chip are relatively moving to each other, and said belt includes:
a first belt located in the lower side of said chip; and
a second belt spaced apart from said first belt and located in the lower side of said chip, and further includes:
a fifth magnet group formed with a plurality of magnets disposed side by side along the diagonal direction in a single line wherein the separation distances between the neighboring magnets are same; and
a sixth magnetic group disposed in parallel with said fifth magnet group, wherein said fifth magnet group and said sixth magnetic group are repeatedly disposed.

11. A magnetic iron particle (MIP) separating system characterized in that and including:
a chip including a channel; and
a plurality of magnets imparting magnetic force to said chip, wherein said magnets and said chip are relatively moving to each other, and a height difference is formed inside said channel.

12. A magnetic iron particle (MIP) separating system characterized in that and including:
a chip including a channel; and
a plurality of magnets imparting magnetic force to said chip, wherein said magnets and said chip are relatively moving to each other, and a slope and a height difference are formed inside said channel.

13. A magnetic iron particle (MIP) separating system characterized in that and including:
a chip including a channel; and
a plurality of magnets imparting magnetic force to said chip, wherein said magnets and said chip are relatively moving to each other, wherein said chip includes:
an upper plate; and
a lower plate being coupled to said upper plate, wherein said channel further includes a height difference formed in said upper plate or said lower plate of said chip, and the height of said channel is constant along the lengthwise direction of said chip.
